(19) United States
(12) Patent Application Publication
(10) Pub. No.: US 2013/0087634 A1
(43) Pub. Date: Apr. 11, 2013

(54) Injection Nozzle System And Ceramic Nozzle Hood

(71) Applicant: Jurgen Nagel, Gettorf (DE)

(72) Inventor: Jurgen Nagel, Gettorf (DE)

(73) Assignee: CATERPILLAR MOTOREN GMBH & CO. KG, Kiel (DE)

(21) Appl. No.: 13/704,402

(22) PCT Filed: Jun. 18, 2011
(86) PCT No.: PCT/EP2011/002818

§ 371 Date: Dec. 14, 2012

(30) Foreign Application Priority Data
Jun. 18, 2010 (EP) 10166502.4
Jun. 18, 2010 (EP) 10166505.7

(51) Int. Cl. F02M 53/04

(52) U.S. Cl. CPC F02M 53/04
USPC 239/128; 239/288; 29/592.1

(57) ABSTRACT

A ceramic nozzle hood used in a fuel injection nozzle system. The ceramic nozzle hood comprises a first member contact face on the inner surface extending essentially in a radial direction with respect to the longitudinal axis and a collar. The collar comprises a second member contact face, which faces away from the injection side, and a mount contact face, which faces towards the injection side. The inner chamber of the ceramic nozzle hood comprises a blind hole section fluidly connected to a remaining section of the inner chamber along the longitudinal axis through the first member contact face and to an outside of the ceramic nozzle hood via a plurality of nozzle spray holes.

### TECHNICAL FIELD

The present disclosure generally refers to an injector and more particularly to an injection nozzle system configured for an injector adapted to be used with alternative fuels and to a method for mounting an injection nozzle system.

### BACKGROUND

Alternative fuels replacing fossil fuels are the subject of ongoing interest, in particular with respect to the replacement of, e.g., diesel fuel, light fuel oil (LFO), and heavy fuel oil (HFO). Alternative fuels include first generation biofuels (e.g. palm oil, canola oil, oils based on animal fat) and second generation biofuels (e.g. oils made of non food corps, i.e. waste biomass).

Examples of second generation biofuel include “pyrolysis oils” obtained from the pyrolysis of, e.g., wood or agricultural wastes, such as the stalks of wheat or corn, grass, wood, wood shavings, grapes, and sugar cane. In general, pyrolysis oil is predominantly produced by the “Fast Pyrolysis” technology, which comprises rapid pyrolysation of biomass in a fluidized bubbling sand bed reactor, wherein the solid heat-carrying medium is circulated and, therefore, the residence time of solids is well-controlled and high heating rates (up to 1000° C./second) are obtained.

The chemical composition and the physical properties of alternative fuels such as pyrolysis oils can differ significantly from those of diesel fuel, LFO, and HFO, in particular with respect to the high content of water and oxygen, the acidic pH value in the range from, e.g., 2 to 3, and the rather low heating value. Moreover, alternative fuels can have poor lubrication properties and usually comprise small size particles in the range of, e.g., 1-5 μm. In addition, the temperature of use is generally lower for alternative fuels than for, e.g., HFO. A temperature of use of 60° C. is common for pyrolysis oil to on the one side provide a viscosity similar to HFO and on the other side avoid becoming paste-like.

As the physical properties and the chemical composition of alternative fuels can cause considerable damage, care has to be taken when alternative fuels are used as a substitute for diesel fuels or light fuel oil in, e.g., large internal combustion engines. In particular, the acidic pH value can cause corrosion that is further increased by the abrasive effect of the small particles when the fuel flows fast through the injection system as it is the case, for example, in the spray holes of an injection nozzle.

In summary, the use of alternative fuels requires an adaptation of the large internal combustion engines to those specific features of alternative fuels.

The use of alternative fuels in internal combustion engines affects in particular the supply of the alternative fuel to a combustion chamber. The supply path includes usually an injection pump systems and an injection nozzle system.

Injection pump systems for supplying fuel to the injection nozzle systems are basically known. Injection pumps of conventional systems as well as common rail systems provide fuel under a high pressure and activate the injection process of the nozzle system with the proper timing. Usually, the injection nozzle systems are attached to a nozzle holder at the injection pump system. An example for a conventional fuel injection pump system is disclosed, e.g., in GB 2 260 374 A, an example for a common rail fuel injection system is disclosed, e.g., in WO 2008/027123 A1.

In general, ceramic materials can be used in nozzle systems for, e.g., insulation purposes at the nozzle tip, see, for example, EP 1 256 712 A3, EP 0 961 024 B1, and JP 58-143161.

An example of a nozzle 10A for HFO-operation as it may be known in the art is shown in FIG. 12. Nozzle 10A includes a needle 12A and a one-piece injection nozzle body 14A. Nozzle body 14A is mounted via a sleeve nut 16A to a nozzle holder 18A. A high-pressure chamber 20A is formed in the center of nozzle 10A between needle 12A and nozzle body 14A. Fuel supply channels (not shown) provide, for example, HFO to high-pressure chamber 20A. During operation, needle 12A is moved to open a fuel path from high-pressure chamber 20A to a blind hole 22A and then through nozzle spray holes 24A into a combustion chamber (not shown). Coolant supply conduits 26A provide a coolant for a circular coolant path 28A within the tip of nozzle body 14A.

Another example of a nozzle 10B as it may be known in the art is shown in FIG. 13. Nozzle 10B includes a needle 12B, a needle guide member 14B, and a hardened steel hood 30B. A double threaded nut 32B provides a thread to interact with a nozzle holder 18B as well as with hardened steel hood 30B. A high-pressure chamber 20B is position close to an injection end of nozzle 10B and connected via a fuel supply conduit 34B with a fuel supply source (not shown). A gap 36B in-between needle guide member 14B and hardened steel hood 30B is used for circulating coolant within the injection end of nozzle 10B. The coolant is supplied via coolant supply conduits from a coolant reservoir (not shown).

The present disclosure is directed, at least in part, to improving or overcoming one or more aspects of the related prior art and particularly to provide a nozzle system for use with alternative fuels.

### SUMMARY OF THE DISCLOSURE

According to a first aspect of the present disclosure, a ceramic nozzle hood that may be configured to be used in a fuel injection nozzle system may have an inner surface that surrounds an inner chamber. The inner chamber may extend along a longitudinal axis and may be closed at an injection side and open at a nozzle holder side, the injection side and the nozzle holder side being at opposite sides of the ceramic nozzle hood along the longitudinal axis. The ceramic nozzle hood may comprise, at the injection side of the ceramic nozzle hood, a first member contact face on the inner surface of the ceramic nozzle hood, the first member contact face may be extending essentially orthogonally to the longitudinal axis, i.e. in a radial direction with respect to the longitudinal axis, and facing towards the nozzle holder side, and, at the nozzle holder side of the ceramic nozzle hood, a collar. The collar may comprise on opposite sides a second member contact face and a mount contact face. The second member contact face may be facing away from the injection side and, for example, extend essentially in a radial direction (or under some angle) with respect to the longitudinal axis. The mount contact face may be facing towards the injection side and, for example, extend essentially in a radial direction (or under some angle) with respect to the longitudinal axis. The inner chamber of the ceramic nozzle hood may comprise a blind hole section at the injection side of the ceramic nozzle hood and the blind hole section may be fluidly connected to a remaining section of the inner chamber along the longitudinal axis through the first member contact face and to an outside of the ceramic nozzle hood via a plurality of nozzle spray holes.

According to another aspect of the present disclosure, a method for mounting an injection nozzle system onto a nozzle holder may include several steps, wherein the injection nozzle system may comprise a needle, a needle guide member configured to guide the needle between a fuel injection state and a sealed state of the injection nozzle system, and a ceramic nozzle hood configured to essentially surround the needle guide member with the exception of a nozzle holder side face of the needle guide member, wherein in an unmounted state of the injection nozzle system a distance between a first member contact face and a second member contact face of the ceramic nozzle hood may be less than a distance between a first hood contact face and a second hood contact face of the needle guide member. The method may include applying a force onto the ceramic nozzle hood in direction of the nozzle holder side of the ceramic nozzle hood, such that the first member contact face of the ceramic nozzle hood contacts the first hood contact face of the needle guide member, thereby forming a first sealing zone. The method may include increasing the force onto the ceramic nozzle hood to stretch the ceramic nozzle hood such that the second member contact face of the ceramic nozzle hood contacts the second hood contact face of the needle guide member, thereby forming a second sealing zone. The method may include further increasing the force onto the ceramic nozzle hood to form a sealed contact between the needle guide member and the nozzle holder.

According to another aspect of the present disclosure, a ceramic nozzle hood configured to be used with a fuel injection nozzle system may extend along a longitudinal axis and may be closed at an injection side and open at a nozzle holder side. The ceramic nozzle hood may comprise, at the nozzle holder side of the ceramic nozzle hood, a collar comprising a face and a mount contact face, the faces extending essentially in a radial direction with respect to the longitudinal axis, and, at the injection side of the ceramic nozzle hood, a contact face on an inner surface of the ceramic nozzle hood. The contact face may have an opening and extend essentially in a radial direction with respect to the longitudinal axis. The ceramic nozzle hood may comprise a blind hole partly enclosing a blind hole section of the inner chamber of the ceramic nozzle hood at the injection side of the ceramic nozzle hood and the blind hole section may fluidly be connected to the inner chamber of the ceramic nozzle hood, e.g., via the opening, and to an outside of the ceramic nozzle hood via a plurality of nozzle spray holes.

According to another aspect of the present disclosure, an injection nozzle system may comprise a needle, a needle guide member configured to guide the needle between a fuel injection state and a sealed state of the injection nozzle system, and a ceramic nozzle hood as described, for example, above.

According to another aspect of the present disclosure, a method for mounting an injection nozzle system onto a nozzle holder using a mount is disclosed, wherein the injection nozzle system may comprise a needle, a needle guide member configured to guide the needle between a fuel injection state and a sealed state of the injection nozzle system, and a ceramic nozzle hood configured to essentially surround the needle guide member with the exception of a nozzle holder side of the needle guide member, and wherein in an unmounted state of the injection nozzle system a distance between a contact face and a face of the ceramic nozzle hood may be less than a distance between corresponding faces of the needle guide member. The method may comprise the step of applying a force onto the ceramic nozzle hood via the mount in direction of the nozzle holder side of the ceramic nozzle hood, such that the contact face of the ceramic nozzle hood contacts the corresponding face of the needle guide member, thereby forming a first sealing zone. The method may further comprise the step of increasing the force onto the ceramic nozzle hood to stretch the ceramic nozzle hood such that the face of the ceramic nozzle hood contacts the corresponding face of the needle guide member, thereby forming a second sealing zone. The method may further comprise the step of further increasing the force onto the ceramic nozzle hood such that the needle guide member contacts the nozzle holder.

The details of one or more embodiments of the invention are set forth in the accompanying drawings and the description below. Other aspects, features, objects, and advantages of the invention will be apparent from the following description and accompanying drawings, and from the claims.

### BRIEF DESCRIPTION OF THE DRAWINGS

FIG. 1 shows a schematic block diagram of an internal combustion engine system;

FIG. 2 shows a cut view of a nozzle system;

FIG. 3 shows a top view of a needle guide member of the nozzle system of FIG. 2;

FIG. 4 shows a cut view of the needle guide member of FIG. 3;

FIG. 5 shows a side view of the needle guide member of FIG. 3;

FIG. 6 shows a side view of a hood of the nozzle system of FIG. 2;

FIG. 7 shows a cut view of the hood of FIG. 6;

FIG. 8 shows a cut view of another nozzle system with a pressure release path;

FIG. 9 shows a cut view of another nozzle system with a pressure release path;

FIG. 10 shows a cut view of a cooled nozzle system;

FIG. 11 shows a cut view of another nozzle system;

FIG. 12 shows a cut view of a cooled prior art nozzle system;

FIG. 13 shows a cut view of another cooled prior art nozzle system;

FIG. 14 shows a cut view of another nozzle system; and

FIG. 15 shows an enlarged view of a tip of the nozzle system of FIG. 14.

### DETAILED DESCRIPTION

The following is a detailed description of exemplary embodiments of the present disclosure. The exemplary embodiments described therein and illustrated in the drawings are intended to teach the principles of the present disclosure, enabling those of ordinary skill in the art to implement and use the present disclosure in many different environments and for many different applications. Therefore, the exemplary embodiments are not intended to be, and should not be considered as, a limiting description of the scope of patent protection. Rather, the scope of patent protection shall be defined by the appended claims.

The disclosure may be based in part on the discovery that the corrosive and abrasive effects of alternative fuel may affect in particular surfaces subject to fast flowing fuel, e.g., the nozzle spray holes of an injection nozzle system and specifically the transition regions from a blind hole wall to nozzle spray hole walls. Particularly in conventional internal combustion systems, any modification of the flow parameters due to corrosion and abrasion may affect the combustion process as operating parameters of the injection pump system are usually only set once at the end of the manufacturing process.

A ceramic nozzle hood configured to be used in an injection nozzle system is disclosed that may provide nozzle spray holes at an injector side and a mounting collar at a nozzle holder side. Spray holes in a ceramic hood may provide the required resistance against physical abrasion and chemical corrosion when used with, for example, alternative fuels such as pyrolysis oil. Moreover, the specific configuration of the ceramic nozzle hood and how it is mounted may allow using the injection nozzle system with conventional nozzle holders, thereby simplifying, for example, the adaptation of a nozzle pump system to the use with alternative fuels. Moreover, using the ceramic nozzle hood may allow replacement of the ceramic nozzle hood, if required, without replacing other parts of the nozzle system.

In addition, an injection nozzle system is disclosed that provides a pressure relief path partly between the hood and the needle guide member. The pressure relief path may avoid braking of a nozzle hood in the case that the sealing between the nozzle hood and a needle guide member cannot be completely achieved or is partly reduced during operation of an internal combustion engine using the injection nozzle system.

In addition, an injection nozzle system is disclosed that applies a configuration of a two-piece injector body with a high pressure chamber arranged close to a nozzle holder side of the injection nozzle system. The high pressure chamber may be connected via a high pressure bore having an angle with respect to a longitudinal axis of about 20° or more. The injection nozzle system further may include a needle guided by two needle guiding zones configured to properly centralize the needle with respect to a valve seat.

The injection nozzle systems disclosed with a pressure relief path and the injection nozzle system with the ceramic nozzle hood disclosed herein may be used with any type of arrangement of a high pressure chamber, including, for example, an arrangement close the nozzle holder side, close to the injection, side or in the central region of the nozzle system.

FIG. 1 shows a non-limiting example of an internal combustion engine system with an injection nozzle system. The internal combustion engine system may include, for example, an engine with a cam injection pump for a conventional pump-line-nozzle injection or an engine with a common rail injection, which may be operated more flexible, e.g., to adjust an injection pressure, a rail pressure, the injection timing, the number and type of injections (e.g., pre- and post-injections).

The internal combustion engine system may include a reservoir 1 for an alternative fuel such as pyrolysis oil and an internal combustion engine 5. Internal combustion engine 5 may be configured to operate, for example, with a mixture of the pyrolysis oil with additives such as mineral oil, synthetic oil, natural oil, and/or a lubricant. Accordingly, the internal combustion engine system may optionally include one or more of reservoirs 2, 3 for the additives. The internal combustion engine system may further include a homogenizer 4. An inlet 4A of homogenizer 4 may be connected via corresponding lines 1A, 2A, and 3A with reservoirs 1, 2, and 3, respectively.

Internal combustion engine 5 may include at least one fuel injection pump 5A connected via one or more lines 4C with an outlet 4B of homogenizer 4, at least one nozzle system 5B and at least one combustion chamber 5C. Nozzle system 5B may be supplied with the pressurized alternative fuel by fuel injection pump 5A and may be configured to spray, e.g., a mixture of the pyrolysis oil, the mineral oil, the synthetic oil, the natural oil, and/or the lubricant into combustion chamber 5C.

The number of fuel injection pumps 5A, nozzle systems 5B, and combustion chambers 5C of internal combustion engine 5 is not specifically restricted. For example, a stationary or mobile power system may include for inline configurations 4, 6, 7, 8, or 9 combustion chambers with one or more associated fuel injection pumps and respective nozzle systems, while a V-configuration of an internal combustion engine may include, for example, 12 or 16 combustion chambers with one or more fuel injection pumps and respective nozzle systems.

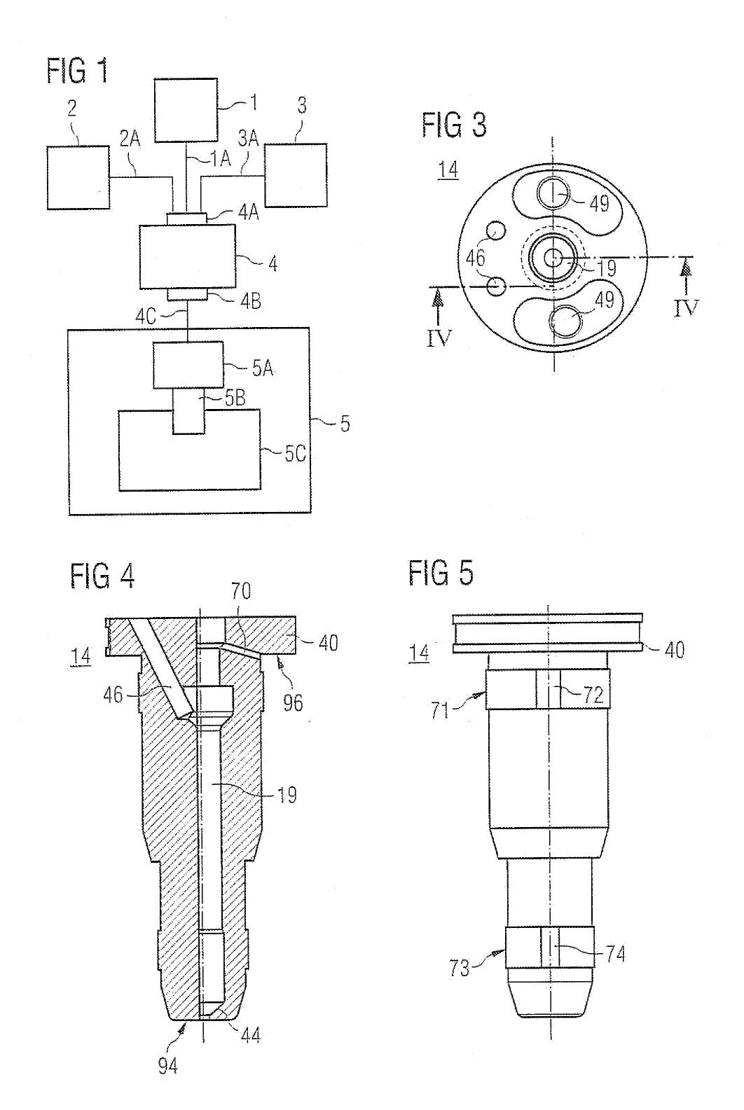

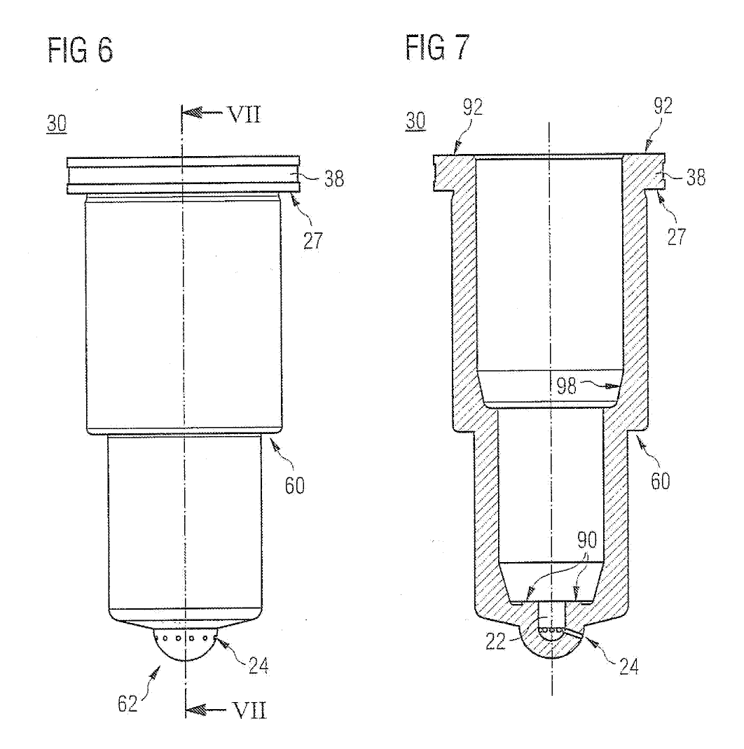

FIG. 2 shows a cut view of an exemplary embodiment of an injection nozzle system 10 adapted for injecting an alternative fuel such as pyrolysis oil into a combustion chamber. Injection nozzle system 10 may induce a needle 12, a needle guide member 14 (separately shown in FIGS. 3 to 5), and a ceramic hood 30 (separately shown in FIGS. 6 and 7).

Needle guide member 14 and ceramic hood 30 may form a two-piece injector body. Ceramic hood 30 may surround needle guide member 14 with the exception of a collar 40 of needle guide member 14 at a nozzle holder side of injection nozzle system 10 and the associated end face of needle guide member 14. At an injection side of injection nozzle system 10, ceramic hood 30 may provide a blind hole partly enclosing a blind hole section 22 and comprise nozzle spray holes 24 in the wall of the blind hole.

The wall of the blind hole may be rotational symmetrical with respect to a longitudinal axis 23 of injection nozzle system 10, e.g. the wall may be bell-shaped, shaped as a half-sphere, or a closed cylinder. Alternatively, the wall may not be rotational symmetrical, e.g. in the form of a cube that is open at one side.

Needle 12 may be positioned in a bore 19 of needle guide member 14 (see FIGS. 3 and 4). Needle 12 may further be movable along bore 19, i.e. needle 12 may be guided by needle guide member 14 between a fuel injecting (open) state and a sealed (closed) state of injection nozzle system 10. The sealed state is shown in FIG. 2.

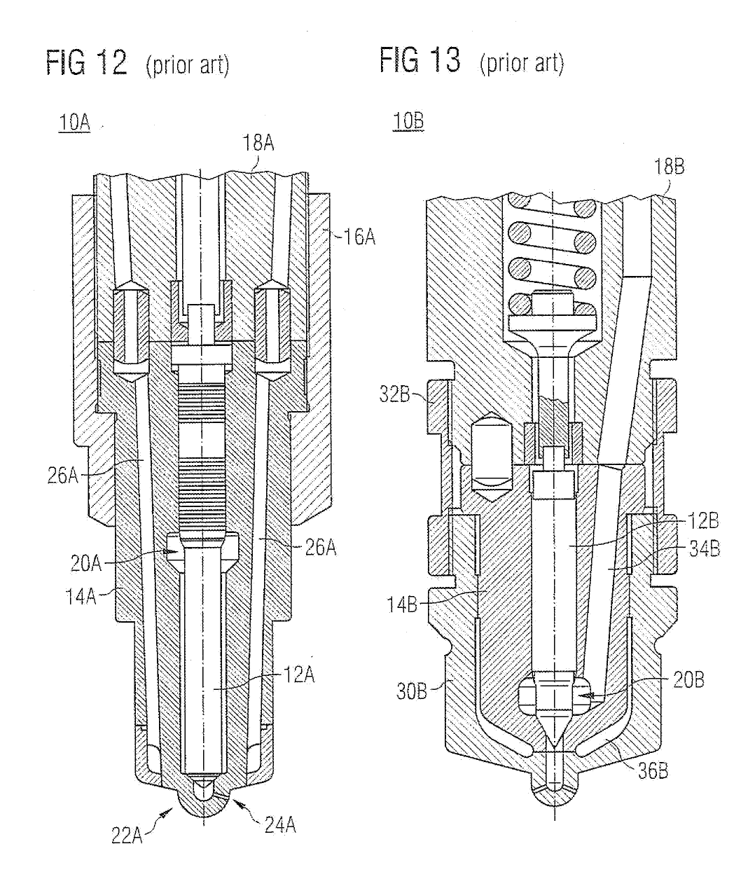

A mount 16 may interact with a nozzle holder 18, for example, via a thread connection (not shown). Mount 16 may be configured to pull ceramic hood 30 towards nozzle holder 18. For example, mount 16 may be a one-sided threaded nut such as sleeve nut 16A of conventional nozzle 10A shown in FIG. 12. In the embodiment of FIG. 2, mount 16 may act onto a mount contact face 27 of a collar 38 of ceramic hood 30.

If mount 16 is moved towards nozzle holder 18, ceramic hood 30 may contact needle guide member 14 at first at a first sealing zone 29 at the injection side of injection nozzle system 10 and then at a second sealing zone 31 at the nozzle holder side of injection nozzle system 10. Collar 40 of needle guide member 14 may extend between collar 38 of ceramic hood 30 and nozzle holder 18. Applying a force onto collar 40 via collar 38 towards nozzle holder 18 may allow forming a seal by tightly contacting opposing surfaces of needle guide member 14 and nozzle holder 18.

As shown in the top view of needle guide member 14 of FIG. 3, two blind holes 49 may be provided in needle guide member 14 to hold bolts that ensure the proper relative position between needle guide member 14 and nozzle holder 18.

Nozzle holder 18 may be configured to interact with injection nozzle system 10 adapted for injecting fuel into a combustion chamber. Specifically, nozzle holder 18 or a pump control system (not shown) may include elements configured to open and/or close a valve that is formed at the injection side of injection nozzle system 10. The valve, e.g., may comprise a valve seat 44 of needle guide member 14 and the tip section of needle 12.

To operate the valve, nozzle holder 18 may provide a force via a stud 42 onto needle 12 that counteracts the force onto needle 12 caused by the supplied pressurized fuel. In a conventional pump-line-nozzle injection system, for example, a spring (not shown) may provide the force that acts via stud 42 onto needle 12 to close the valve by pressing needle 12 onto valve seat 44 thereby sealing an opening of valve seat 44. In contrast, in a common rail injection pump system, the force may be applied by a pressurized hydraulic system (not shown).

Bore 19 may be shaped to form a high pressure fuel chamber 20 between needle 12 and needle guide member 14. High pressure chamber 20 may be located close to the nozzle holder side of injection nozzle system 10, e.g. within the first third of the nozzle system 10. High pressure chamber 20 may be connected via, e.g., one, two or more high pressure supply bores 46 (two high pressure supply bores are shown, e.g., in the top view of needle guide member 14 of FIG. 3) with corresponding high pressure supply conduits 48 of nozzle holder 18. High pressure supply conduits 48 may be connected with sources of pressurized fluids, e.g., the alternative fuel and/or additives that are usually provided by an injection pump system.

Needle guide member 14 may be dimensioned such that it does not deform when fuels under high pressure are supplied into high pressure supply bores 46, high pressure chamber 20, and bore 19.

Together with the requirement to provide a similar or the same outer geometry of nozzle 10A of FIG. 12, the configuration of the two-piece injector body may result in that high pressure supply bores 46 extend at a steep angle with respect to longitudinal axis 23 of injection nozzle system 10. For example, high pressure supply bores 46 may extend at an angle larger than 20°, for example, 25°, 30°, 35° or 40° with respect to longitudinal axis 23.

The two-piece injector body may result further in that the position of high pressure chamber 20 is close to the nozzle holder side of injection nozzle system 10. For example, high pressure chamber 20 may be positioned within the nozzle holder half next to nozzle holder 18, e.g. at about one third or one fourth of the length of needle guide member 14.

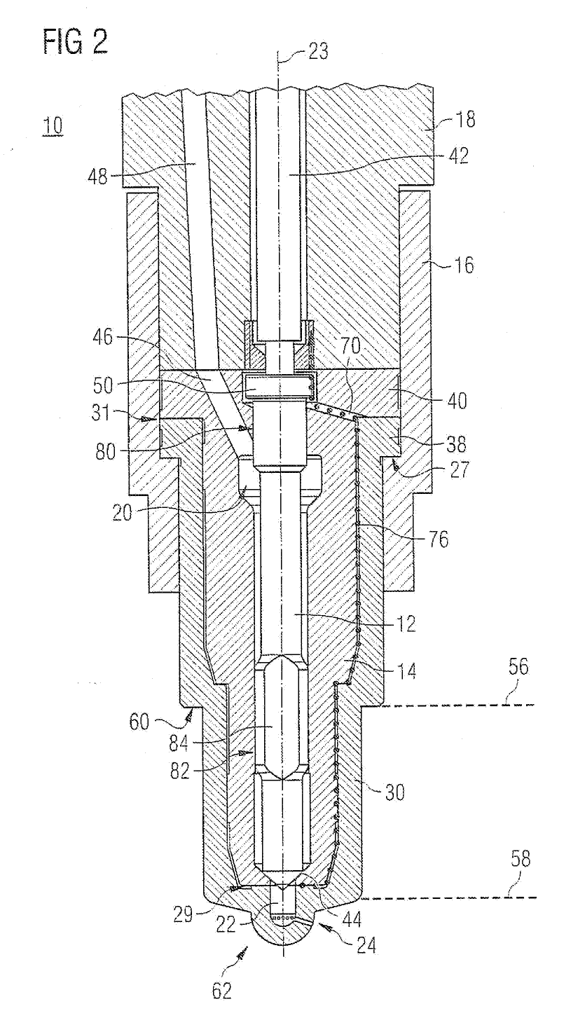

The cut view of needle guide member 14 of FIG. 4 illustrates the position of high pressure chamber 20 at about 20% of the length of needle guide member 14. In FIG. 4, needle guide member 14 is cut along the line IV-IV shown in FIG. 3, i.e. through one of high pressure supply bores 46 and a drainage 70. As explained below, drainage 70 may constitute together with the gap between ceramic hood 30 and needle guide member 14 and leakage passages 72 and 74 (shown in FIG. 5) a pressure relief path 76 (shown in FIG. 2).

The above discussed requirement for the outer geometry of injection nozzle system 10 may result further in a short first needle guiding section 80 at the nozzle holder side of nozzle system 10. At the nozzle holder side of nozzle system 10, needle 12 and in particular a needle collar 50 may provide a seal for the pressurized fuel in high pressure chamber 20 in direction of nozzle holder 18.

As the length of first needle guiding section 80 and therefore of collar 50 may be restricted in the configuration of the two-piece injector body, the leakage through the seal towards nozzle holder 18 may be slightly increased compared to a longer needle guiding section. In particular for alternative fuels such as pyrolysis oil, an increased leakage may have the advantage that a steady leaking flow of the fuel may be ensured and thereby solidification of the fuel in an outer drainage line (not shown) may be avoided, specifically for the case that the internal combustion engine is not operated and, for example, has cooled down.

A second needle guiding section 82 at the injection side of needle 12 may be provided to assist the centering of needle 12 on valve seat 44. In that case, needle 12 may contact needle guide member 14 at first needle guiding section 80 and second needle guiding section 82 and in the sealed valve state additionally at needle seat 44.

An embodiment having only a single needle guiding section and a more centralized high pressure chamber is described in connection with FIG. 13.

Referring to FIG. 2, bore 19 and needle 12 may be further configured to provide a high pressure fuel path from high pressure chamber 20 to valve seat 44. The high pressure fuel path accordingly may pass through second needle guiding section 82, which, for example, may be formed by two, three or more, e.g. planes or ridges contacting the wall of bore 19 and having fuel channels 84 in between.

At the injection side, the opening of valve seat 44 of needle guide member 14 may be sealed by the tip of needle 12 thereby controlling the injection of the alternative fuel.

On the external side of the opening of valve seat 44, i.e. outside bore 19, blind hole section 22 may be enclosed by ceramic hood 30 (with the exception of the opening of the blind hole).

Ceramic hood 30 is shown in detail in FIGS. 6 and 7. FIG. 6 shows a side view of ceramic hood 30 with collar 38, while FIG. 7 shows a cut view along the line VII-VII indicated in FIG. 6.

Blind hole section 22 may be fluidly connected via spray holes 24 to the outside of ceramic hood 30, i.e. in the mounted state to the inside of the combustion chamber (cylinder head). In FIG. 2, a wall of a cylinder head is indicated by dashed lines 56 and 58.

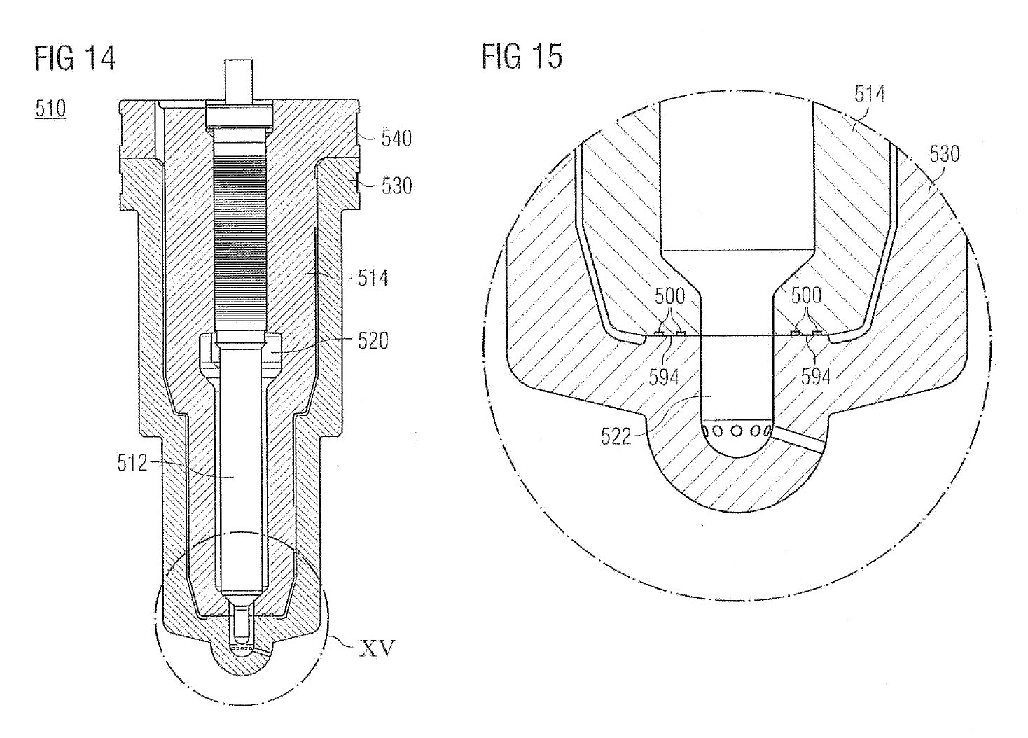

In injection nozzle system 10, a high pressure seal may be formed between needle guide member 14 and ceramic hood 30 in first sealing zone 29. Thus, in the fuel injecting state of nozzle system 10, pressurized fuel may only leave blind hole section 22 through spray holes 24 and the fuel may eject with high speed through spray holes 24. Accordingly the high corrosive and abrasive feature of the alternative fuel may be supplemented with a high mechanical abrasion of the fast flowing alternative fuel and the small sized particles carried along with it. Further details, which may be applicable to the various nozzle systems disclosed herein, are described in connection with FIG. 14.

Ceramic hood 30 being made of engineering ceramics such as zirconium oxide or aluminum oxide may be configured to resist the chemical corrosive and mechanical abrasive attack.

Moreover, if spray holes 24 are modified through the abrasion such that the operation of injection nozzle system 10 does no longer fulfill its requirements, the configuration of the two-piece injector body may allow replacing only ceramic hood 30 while keeping needle 12 and needle guide member 14 unchanged.

In the mounted state, injection nozzle system 10 may reach through the wall of the cylinder head. A cylinder head contact face 60 of ceramic hood 30 may contact the wall of the cylinder head or a bushing (e.g. a stainless steel sleeve) inserted into a hole of the wall of the cylinder head. Accordingly, only an end face 62 of ceramic hood 30 that includes spray holes 24 may be exposed to the inside of the combustion chamber and may experience directly the heat and pressure caused by the combustion process in the combustion chamber.

Thus, besides the above described resistance against abrasive and corrosive wear, using an engineering ceramic for ceramic hood 30 may provide thermal insulation of nozzle system 10 from heat generated in the combustion chamber.

In some configuration, the use of a ceramic hood may avoid the necessity of a cooling system adapted for cooling injection nozzle system 10. This may in particular be the case for alternative fuels, which are supplied at a relatively low temperature of about 60° C. in contrast to HFO supplied at 150° C.

Referring again to FIGS. 6 and 7, ceramic hood 30 may be a separate part with spray holes 24 having a diameter of, e.g., about 0.7 to 0.8 mm. The specific shape of spray holes 24 may be essential for the injection process. This may be in particular the case for conventional pump-line-nozzle injection systems, which require an initial adjustment of the pump parameters for a specific spray hole configuration. During operation, changes of the shape of spray holes 24 due to abrasive and corrosive wear may affect directly the fuel distribution in the combustion chamber and, therefore, the combustion process such as efficiency and soot formation because an adjustment of the pump parameters may usually not be possible. Despite its larger flexibility in the injection process, also common rail injection systems may be sensitive for geometrical changes due to abrasive and corrosive wear of the shape of spray holes 24.

In contrast to a ceramic coating, ceramic hood 30 may be mounted as a separate part and may enclose essentially the complete needle guide member 14 with the exception of one face (for contacting the nozzle holder) and collar 40. In general, ceramic hood 30 may be not in contact with needle guide member 14 with the exception that there may be contact at first sealing zone 29 and second sealing zone 31 in the mounted state. Some loose contact may exist at a first guiding collar 71 and a second guiding collar 73, which include leakage passages 72 and 74, respectively. The surface of ceramic hood 30 may, for example, be grinded to avoid any force transmission from needle guide member 14 at those collars 71 and 73.

To provide the high pressure seal at first sealing zone 29 and to also ensure the sealed mounting of needle guide member 14 to nozzle holder 18, ceramic hood 30 may be mounted under tensile stress between first sealing zone 29 and second sealing zone 31. To provide the tension in the mounted state, the length between a first member contact face 90 and a second member contact face 92 of ceramic hood 30 (which are adapted for contacting needle guide member 14) may be—in the unmounted state—shorter than the length between a first hood contact face 94 and a second hood contact face 96 of needle guide member 14 (which are adapted for contacting ceramic hood 30) by a predefined amount.

The predefined amount may be chosen such that when ceramic hood 30 is pulled towards nozzle holder 18 and is in contact with second hood contact face 96 of needle guide member 14, the tensile force within ceramic hood 30 may be preferably still in the range of elastic behavior but may provide a sufficient sealing between hood 30 and needle guide member 14 and needle guide member 14 and nozzle holder 18. FIG. 14 illustrates an exemplary configuration of sealing zone 29 using circular grooves 500 to improve the sealing by reducing the contacted surface area.

However, although the transition between nozzle holder 18 and needle guide element 14 may be subject to a larger force applied by mount 16, ceramic hood 30 may then only be subject to a predefined tensile stress. The predefined tensile stress may be below a critical tensile stress, thereby ensuring safe operation of nozzle system 10.

For example, the difference in length may be 0.05 mm or less or 0.03 mm or less, depending on the type of ceramic material and/or the thickness of the wall of the ceramic hood 30. To provide such a specific difference in length, besides high precision manufacturing, a specific pair of a hood and needle guide member may be selected from a set of pre-manufactured hoods and needle guide members, thereby allowing a lower precision during manufacture.

To summarize the exemplary configuration of hood 30 shown in FIGS. 2, 6, and 7, hood 30 may comprise, at the nozzle holder side of hood 30, collar 38 that may have a second member contact face 92 and mount contact face 27 on opposite sides. Faces 92 and 27 may extend essentially in a radial direction with respect to longitudinal axis 23. Alternatively, one or both faces 92 and 27 may be configured to have some tilt at a predefined angle with respect to the longitudinal direction. Moreover, hood 30 may comprise, at the injection side of hood 30, first member contact face 90 on an inner surface of hood 30 and first member contact face 90 may have an opening and extend essentially orthogonal, i.e. in a radial direction, with respect to longitudinal axis 23. Moreover, hood 30 may form blind hole section 22 of the inner chamber at the injection side of hood 30. Blind hole section 22 may be fluidly connected to the inside of hood 30, e.g., via the opening in first member contact face 90, and to an outside of hood 30 via a plurality of nozzle spray holes 24.

The blind hall section 22 being a part of the inner chamber formed by the nozzle hood 30 may be fluidly connected with the remaining section (volume) of the inner chamber. The fluid connection between the blind hole section 22 and the remaining section may pass through, e.g. the center of first sealing zone 29 along longitudinal axis 23.

Moreover, hood 30 may comprise a region in which the radial extension of hood 30 is changed. There, an inclined face 98 on the inside may extend at an angle smaller than 50°, e.g., 40°, 35°, 30°, 25°, 20°, or 15°, with respect to longitudinal axis 23 for providing a smooth change of geometry in that region. In that central region, hood 30 may further comprise cylinder head contact face 60 on the outer surface of hood 30 extending essentially orthogonal with respect to longitudinal axis 23 (or having a predefined inclination therewith).

Inclined face 98 may provide a specific stress distribution in the mounted states, i.e. before being mounted to the cylinder head and once cylinder head contact face 60 being in contact with, e.g., the cylinder head.

In the embodiment of FIG. 2, hood 30 may be cylindrically shaped, and at least one of first member contact face 90, mount contact face 27, second member contact face 92 and cylinder head contact face 60 may be ring-shaped.

First member contact face 90 may have a high quality, e.g. plan-parallel surface shape to allow the required sealing performance in the mounted state and the applied high fuel pressures.

To further make ceramic hood 30 resistant against tensile stress, smooth transitions at diameter changes may be provided. For example, at the diameter change in the central part of ceramic nozzle close to cylinder head contact face 60, inclined face 98 may provide a smooth transmission of force within ceramic hood 30 and, thereby, smoothen the stress profile.

In injection nozzle system 10, first member contact face 90 may be configured to form a high pressure sealing with first hood contact face 94 of needle guide member 14, when a force is applied onto mount contact face 27 in direction of the nozzle holder side of hood 30. In an unmounted state of injection nozzle system 10, a distance between first member contact face 90 and second member face 92 of hood 30 may be less than a distance between corresponding faces 94, 96 of the needle guide member 14, thereby providing a tensile stress within hood 30 in a mounted state of injection nozzle system 10.

As mentioned above, drainage 70 may provide together with leakage passages 72 and 74 (shown in FIG. 5) a pressure relief path 76 (shown in FIG. 2). During operation of, e.g., pump-line-nozzle injection, maximum pressures in the range of, e.g., about 1500 bar to 1700 bar may occur within injection nozzle system 10. If a proper high pressure seal may be maintained in first sealing zone 29 during operation, only the small inside surface of the blind hole forming blind hole section 22 of ceramic hood 30 is subject to those pressures.

However, in the case of leakage of high pressure fuel through first sealing zone 29, those pressures of the pressurized fuel may act onto the large inside surface of ceramic hood 30. For example, the relevant surface subject to the maximum pressure along longitudinal axis 23 may correspond essentially to the diameter of ceramic hood 30 (without collar 38). The resulting large force may then destroy ceramic hood 30 if no countermeasures are taken.

Injection nozzle system 10 therefore may provide pressure relief path 76 to release any leaking fuel along an unpressurized path. Specifically, any fuel leaking through first sealing zone 29 may pass through the gap between needle guide element 14 and ceramic hood 30 in direction of nozzle holder 18. In the region of collar 38, drainage 70 may guide the fuel towards collar 50 of needle 12, where pressure relief path 76 may combine with a leakage path through first needle guiding section 80. Thus, pressure relief path 76 may allow a controlled removal of the fuel.

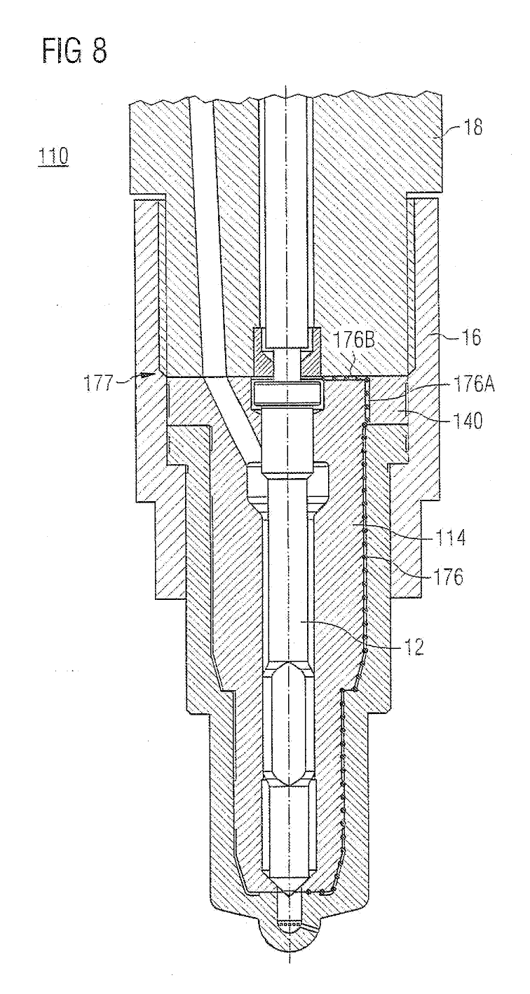

In FIG. 8, a pressure relief path 176 is illustrated in an injection nozzle system 110 that may be applied alternatively or additionally with pressure relief path 76. Specifically, pressure relief path 176 may distinguish from pressure relief path 76 with respect to drainage 70. Instead of directing drainage 70 towards needle collar 50 within needle guiding section 80, pressure relief path 176 may include an axial pressure relief bore 176A within a needle guide member 114 and a radial pressure relief channel 176B in a contact zone 177 of needle guide member 114 and nozzle holder 18 that may extend radially inward towards needle 12.

In FIG. 8, axial pressure relief bore 176A may extend in axial direction parallel to longitudinal axis 23 through collar 140 approximately at a radial distance corresponding to the inner diameter of hood 30 at the nozzle holder side. Radial pressure relief channel 176B may be formed, for example, as a groove on the face of needle guide member 114 contacting needle holder 18.

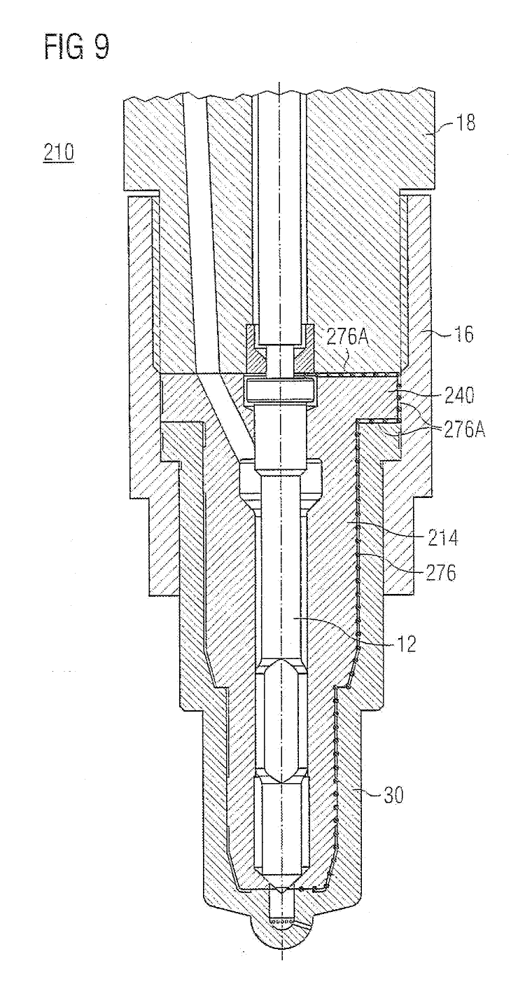

In FIG. 9, a pressure relief path 276 is illustrated for an injection nozzle system 210 that may be applied alternatively or additionally with one or both pressure relief paths 76 and 176. Specifically, pressure relief path 276 may distinguish from those paths with respect to drainage 70 and pressure relief bore 176A. Instead of providing drainage 70 or bore 176A, pressure relief path 276 may include surface pressure relief channel 276A that may extend in the plane of the cut view of FIG. 9 along the surface of collar 240 of needle guide member 214.

The herein disclosed concept of a pressure relief path may also be applied with two-piece injector bodies that use non-ceramic nozzle hoods.

Although the above described ceramic nozzle hood concept may sufficiently insulate the nozzle system from the high temperatures of the combustion chamber, the configuration of the two-piece injector body may also allow an additional implementation of a cooling system to provide cooling and prevent any damage to the injection nozzle system. Such cooling may prevent, for example, damaging valve seat 44 or weakening the high pressure seal in first sealing zone 29 between needle guide member 14 and hood 30 in FIG. 2.

In addition, a cooling system may absorb leakage through first sealing zone 29 next to valve seat 44 and, therefore, may include additionally the functionality of a high pressure relief path to avoid destruction of ceramic hood 30 due to over pressure. In that case, a pressure relief path as discussed above in connection with FIGS. 2, 8, and 9 may not be required.

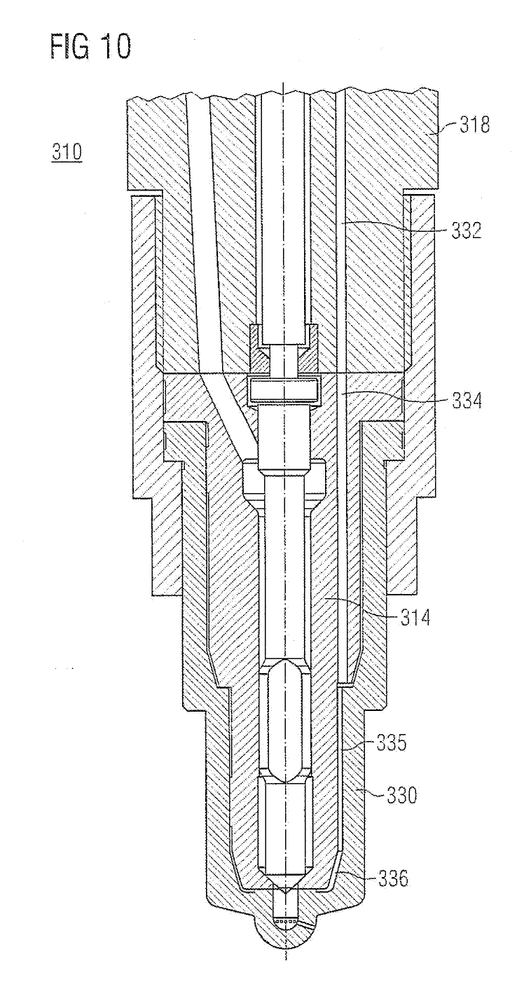

In FIG. 10, a cut view of a nozzle system 310 illustrates an example of an injection nozzle system 310 with exemplary coolant system. The coolant system may be based on circulating a coolant along a supply path, a coolant circulation ring, e.g. a gap 336, and a return path similar to the supply path (not shown in the cut view of FIG. 10).

The supply path may include, for example, a coolant supply 332 within a nozzle holder 318, a coolant bore 334 within a needle guide member 314, and a coolant supply channel 335, e.g. a groove on the surface of needle guide member 314. The coolant circulation ring may extend at the injection side of nozzle system 310 between a ceramic hood 330 and needle guide member 314.

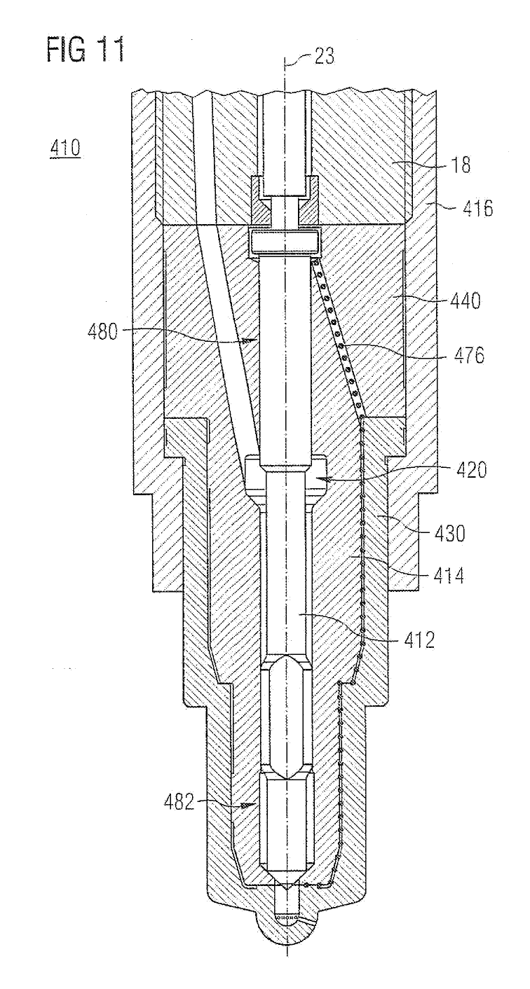

In FIG. 11, a further embodiment of an injection nozzle system 410 is shown. To increase the guidance of a needle 412 within a needle guide member 414, a ceramic hood 430 may be reduced in overall length and a collar 440 of needle guide member 414 is made respectively longer. Accordingly, a modified mount 416 (compared to mount 16) may be required when injection nozzle system 410 is used with conventional nozzle holder 18.

Due to the increased longitudinal extension of collar 440 (compared to collar 40), a needle guidance section 480 may have also a longer longitudinal extension and thereby increase its capability to guide needle 412. Thus, a second needle guidance section 482 may or may not be required. Also the position of a high pressure chamber 420 may be closer to the middle of nozzle system 410 and the angle between a high pressure supply bore 446 and the longitudinal axis 23 may be reduced.

A pressure relief path 476 is illustrated exemplarily in FIG. 11 but may also be configured similar to the pressure relief paths shown in FIGS. 8 and 9. Thus, the concept of the pressure relief path is not restricted to the configuration shown in, e.g., FIG. 2, in which ceramic hood 30 essentially surrounds needle guide member 14, but may also be applied to other configurations of two-piece injector bodies that provide a gap between a ceramic hood and a needle guide member.

FIG. 13 shows a further embodiment of an injection nozzle system 510 with a collar 540 of needle guide member 414 that is made longer and thereby allows a lower lying high pressure chamber 520.

Due to the lower lying high pressure chamber 520, a longer needle guidance section 480 with an increased capability to guide a needle 512 may be provided. Thus, a second needle guidance section may not be provided.

Needle 512 may have a needle extension to reduce the remaining volume of a blind hole section 522 of a hood 530. An example of needle 512 is disclosed in European Patent Application EP 11 154 313.8.

FIG. 14 shows the tip section of injection nozzle system 510 of FIG. 13, specifically hood 530 and needle guide member 514 (without needle 512). FIG. 14 illustrates exemplarily a configuration of a first hood contact face 594 that may generally allow increasing the sealing between hood 530 and needle guide member 514. Such a configuration may be applied in any hood configuration and in particular in the configurations disclosed herein.

In injection nozzle system 510, first hood contact face 594 may include, for example, a pair of grooves 500 that reduce the surface area being in contact with hood 530 in the mounted state, thereby increasing the sealing pressure. For example, grooves 500 may be configured to be circular and concentric with respect to each other. While FIG. 14 shows two grooves 500, one or more than two grooves may be provided. As an example, grooves 500 may have a width of 0.4 mm and a depth of 0.2 mm. In some embodiments the contacted area may be reduced, for example, to 60%.

For the various injection nozzle systems disclosed herein, materials for use with alternative fuels may have an increased corrosion resistance. For the needle guide members and the needles, the materials may be sufficiently resistant with respect to slow flowing fuels (reduced mechanical abrasion compared to the spray holes) and with respect to the chemical exposure to the acidity (i.e., to a low pH value) of, e.g., alternative fuels.

Exemplary materials for needle guide members and for needles include tempered tool steel and, in particular, austenitic steel, e.g. cobalt-chromium steel. In addition, all or selected sections of the surfaces of the needles or needle guide members may be coated with diamond-like carbon (DLC).

Exemplary materials for the hoods may include engineering ceramics such as oxide ceramics and non-oxide ceramics or other ceramic materials that are resistant against corrosion and abrasion by e.g. acidic alternative fuels (or a combination of two or more of those materials).

Examples for oxide ceramics may include aluminum oxide, magnesium oxide, aluminium titanate, titanium dioxide and zirconium dioxide (including, e.g., partially stabilized (PSZ), fully stabilized (FSZ), and tetragonal zirconia polychristal (TSZ)).

Examples for non-oxide ceramics may include carbides and nitrides. Exemplary carbides include silicium carbide (SiC) (e.g., recrystallized SiC, nitride bonded SiC, pressureless sintered SiC, silicon infiltrated SiC, hot pressed SiC, hot isostatically pressed SiC, liquid phase sintered SiC), boron carbide, and tungsten carbide. Exemplary nitrides include silicon nitride (SN) (e.g., sintered SN, reaction-bonded SN, hot pressed SN), silicon oxy-nitride, aluminium nitride, boron nitride, and titanium nitride.

In some embodiments, the hood may also be made of the materials discussed above for the needle and/or the needle guiding member.

In some embodiments, one or more of the various faces, which are shown in the drawings for the disclosed embodiments to extend in a radial extension, specifically faces 27 and 92, may include sections that extend at an angle of e.g. 5°, 10°, 15°, 20°, 25°, or 30° with respect to the radial direction (which is e.g. orthogonal to the longitudinal direction 23 shown in FIG. 2).

Exemplary dimensions for an injection nozzle system disclosed herein may include a length of the hood and needle guide element of about 100 mm, an outer diameter of the hood of about 40 mm, a wall thickness of the ceramic hood of about 5 mm. The difference in length discussed above for the hood and the needle guide member in the unmounted state is, for example, 1/10.000 of the length of the hood, i.e. the ceramic hood stretches by several ten micrometer.

Although the figures show hood configurations that do not surround the collar of the needle guide element, the ceramic hood may generally also be shaped to extend at least partly over the collar, e.g., collar 40 in FIG. 4, specifically beyond second hood contact face 96 onto the radial outside face of collar 40. For example, a hood may only not cover the face of the needle guide element directed to the nozzle holder.

In general, it may be advantageous to provide a hood with a distance between the needle guide member contacting faces that is as large as possible to increase the effective length of the hood onto which the tensile stress may be distributed.

In general, the relative difference in the distance between the respective contact faces of the needle guide member and the ceramic hood may provide a predefined pretension of the hood and, therefore, a predefined sealing force. Depending on, e.g., the type of the material, e.g. ceramic, and the thickness of the hood, this relative difference may vary for optimal sealing. The herein disclosed relative difference in length may take also into consideration that the mounting of, e.g., injection nozzle system 10 to the cylinder head may cause an additional stress onto, e.g., ceramic hood 30 via cylinder head contact face 60, which may also affect the stress profile within ceramic hood 30.

Although the drawings show primarily rotational symmetric configurations of the outer shape of the injection nozzle systems and therefore needle guiding elements and hoods, also other shapes such as square or oval shapes may be in general be provided.

### INDUSTRIAL APPLICABILITY

The disclosed injection nozzle systems may allow maintaining an outer shape of a conventional nozzle system such as conventional nozzle system 10A shown in FIG. 10. Thus, the disclosed nozzle systems may thereby simplify the modification of injection systems adapted for use with alternative fuels such as pyrolysis oil. Moreover, the disclosed nozzle system may fulfill geometric boundary conditions of known nozzle system, thereby simplifying a replacement of a conventional nozzle system with the herein disclosed nozzle systems.

Herein, the term “large internal combustion engine” may refer to internal combustion engines which may be used as main or auxiliary engines of stationary power providing systems such as power plants for production of heat and/or electricity as well as in ships/vessels such as cruiser liners, cargo ships, container ships, and tankers.

In addition, the term “internal combustion engine” as used herein is not specifically restricted and comprises any engine, in which the combustion of a fuel occurs with an oxidizer to produce high temperature and pressure gases, which are directly applied to a movable component of the engine, such as pistons or turbine blades, and move it over a distance thereby generating mechanical energy. Thus, as used herein, the term “internal combustion engine” comprises piston engines and turbines, which can, for example, be operated with alternative fuels such as pyrolysis oil.

Examples of such engines that are suitable for adaptation to alternative fuels include medium speed internal combustion diesel engines, like inline and V-type engines of the series M20, M25, M32, M43 manufactured by Caterpillar Motoren GmbH & Co. KG, Kiel, Germany, operated in a range of 500 to 1000 rpm.

In some embodiments, injection nozzle systems may comprise one or more features of a needle, a needle guide member comprising a bore configured for guiding the needle between a fuel injection state and a closed state of the injection nozzle system, and a nozzle hood, e.g., a ceramic nozzle hood, surrounding essentially the needle guide member with the exception of a face of the needle guide member at a nozzle holder side of the injection nozzle system. The nozzle hood may comprise a blind hole and the inner chamber of the hood may comprise a blind hole section fluidly connected via an opening to a high pressure fuel path of the injection nozzle system and via a plurality of nozzle spray holes to an outside of the hood at an injection side of the injection nozzle system. The bore of the needle guide member may be configured to provide a high pressure chamber within an upper third of the needle guide member next to the nozzle holder side and a high pressure supply bore may be configured to connect the high pressure chamber with the face of the needle guide member at the nozzle holder side and to be inclined with respect to a longitudinal axis of the nozzle system at an angle greater than 20°.

Alternative or additional implementations of injection nozzle systems may further include, for example, one or more of the following features.

In injection nozzle systems, the supply bore may be connected to the high pressure chamber at a position that is located at 35%, 30%, 25%, 20%, or 15% of the length of the needle guide member measured from the nozzle holder side.

In injection nozzle systems, the high pressure supply bore may be inclined with respect to the longitudinal axis of the nozzle system at an angle greater than 25°, 30°, 35° or 40°.

In injection nozzle systems, a material thickness of the needle guide member around the high pressure supply bore and the bore may be configured to essentially not deform under the pressure of a supplied pressurized fuel during operation.

In injection nozzle systems, the bore may comprise a first needle guiding section between the high pressure chamber and a collar of the needle. The length of first needle guiding section may be 30%, 20%, 15%, 10% or 5% of the extension of the needle guiding member along the longitudinal axis.

In injection nozzle systems, the bore may comprise a second needle guiding section close to the injection side that is in interaction with the needle. The second needle guiding section may comprise regions in which the needle and the bore contact each other and regions that provide a passage for the pressurized fuel during operation. The second needle guiding section may be configured to assist centralizing needle on a valve seat of the needle guide member.

In injection nozzle systems, a plurality of high pressure supply bores may be configured to supply one or more fluids to the high pressure chamber during operation.

In injection nozzle systems, the needle guiding member may be configured to form a valve seat with an opening at the injection side, and the needle may be configured for sealing the opening of the valve seat.

In injection nozzle systems, a nozzle hood may be configured to essentially surround the needle guide member with the exception of a face of the needle guide member at a nozzle holder side of the injection nozzle system, the nozzle hood comprising a blind hole such that a blind hole section of an inner chamber of the hood is fluidly connected, e.g., via an opening, to a high pressure fuel path of the injection nozzle system and via a plurality of nozzle spray holes to an outside of the nozzle hood. In the mounted state, the nozzle hood and the needle guide member may contact each other essentially only at a first sealing zone and at a second sealing zone and form a gap between the hood and the needle guide member and the gap may be limited by the first sealing zone and the second sealing zone, and the injection nozzle system may comprise a pressure relief path connecting the gap with an outside of the injection nozzle system at the nozzle holder side.

In injection nozzle systems, the needle may comprise a collar at the nozzle holder side and the needle guide member may comprise a bore in which the needle is positioned and a drainage connecting the gap with the bore in a region of the collar of the needle.

In injection nozzle systems, the needle guide member may comprise a collar, a pressure relief bore within the collar, and a channel formed on a face of the needle guide member at a nozzle holder side, the pressure relief bore connecting the gap with the channel and extending radially inwards.

In injection nozzle systems, the channel may be a groove on the face of the needle guide member at the nozzle holder side.

In injection nozzle systems, the needle guide member may comprise a channel formed on a surface of a collar of the needle guide member and extending from the gap to a central region of the face of the needle guide member at the nozzle holder side.

The pressure relief path may be configured to provide a low pressure passage for fuel leaking through the first sealing zone during operation.

In injection nozzle systems, the nozzle hood may be made of an engineering ceramic such as zirconium oxide or aluminium oxide.

Injection nozzle systems may be configured such that the nozzle hood and the needle guide member contact each other essentially only at the first sealing zone and at the second sealing zone in the mounted state.

The following aspects relate to subject-matter disclosed herein:

Aspect 1: An injection nozzle system (10), comprising

a needle (12),

a needle guide member (14) comprising a bore (19) configured for guiding the needle (12) between a fuel injection state and a closed state of the injection nozzle system (10), and

a nozzle hood (30) surrounding essentially the needle guide member (14) with the exception of a nozzle holder side face of the needle guide member (14) at a nozzle holder side of the injection nozzle system (10), the nozzle hood (30) comprising a blind hole section (22) fluidly connected to a high pressure fuel path of the injection nozzle system (10) and to an outside of the nozzle hood (30) at an injection side of the injection nozzle system (10) via a plurality of nozzle spray holes (24),

wherein the bore (19) of the needle guide member (14) forms a high pressure chamber (20) within an upper third of the needle guide member (14) next to the nozzle holder side, and a high pressure supply bore (46) extends from the high pressure chamber (20) and opens at the nozzle holder side face of the needle guide member (14).

Aspect 2: The injection nozzle system (10) of Aspect 1, wherein the supply bore (46) opens to the high pressure chamber (20) at a position that is located at 35%, 30%, 25%, 20%, or 15% of the length of the needle guide member (14) measured from the nozzle holder side.

Aspect 3: The injection nozzle system (10) of Aspect 1 or 2, wherein the high pressure supply bore (46) is inclined with respect to the longitudinal axis (23) of the nozzle system (10) at an angle greater than 20°, 25°, 30°, 35° or 40°.

Aspect 4: The injection nozzle system (10) of any one of Aspects 1 to 3, wherein a material thickness of the needle guide member (14) around the high pressure supply bore (46) and the bore (19) is configured to essentially not deform under the pressure of a supplied pressurized fuel during operation.

Aspect 5: The injection nozzle system (10) of any one of Aspects 1 to 4, wherein the bore (19) comprises a first needle guiding section (80) between the high pressure chamber (20) and a collar (50) of the needle (12).

Aspect 6: The injection nozzle system (10) of Aspect 5, wherein the length of first needle guiding section (80) is 30%, 20%, 15%, 10% or 5% of the extension of the needle guiding member (14) along the longitudinal axis (23).

Aspect 7: The injection nozzle system (10) of any one of Aspects 1 to 6, wherein the bore (19) comprises a second needle guiding section (82) close to the injection side, second needle guiding section (82) being in interaction with the needle (12).

Aspect 8: The injection nozzle system (10) of Aspect 7, wherein the second needle guiding section (82) comprises regions in which the needle (12) and the bore (19) contact each other and regions that provide a passage for the pressurized fuel during operation.

Aspect 9: The injection nozzle system (10) of Aspect 7 or 8, wherein the second needle guiding section (82) is configured to assist centralizing the needle (12) on a valve seat (44) of the needle guide member (14).

Aspect 10: The injection nozzle system (10) of any one of Aspects 1 to 9, wherein a plurality of high pressure supply bores (46) is configured to supply one or more fluids to the high pressure chamber (20) during operation.

Aspect 11: The injection nozzle system (10) of any one of Aspects 1 to 10, wherein the needle guiding member (14) is configured to form a valve seat (44) with a valve opening at the injection side, and the needle (12) is configured for sealing the valve opening of the valve seat (44).

Aspect 12: The injection nozzle system (10) of any one of Aspects 1 to 11, wherein the nozzle hood (30) comprises one or more engineering ceramics including at least one of oxide ceramics such as zirconium oxide or aluminium oxide and non-oxide ceramics such as carbide ceramics and nitride ceramic.

Although the preferred embodiments of this invention have been described herein, improvements and modifications may be incorporated without departing from the scope of the following claims.

1. A ceramic nozzle hood configured to be used in a fuel injection nozzle system, the ceramic nozzle hood having an inner surface that surrounds an inner chamber, the inner chamber extending along a longitudinal axis and being closed at an injection side and open at a nozzle holder side, the injection side and the nozzle holder side being at opposite sides of the ceramic nozzle hood along the longitudinal axis, the ceramic nozzle hood comprising:
at the injection side of the ceramic nozzle hood, a first member contact face on the inner surface of the ceramic nozzle hood, the first member contact face extending essentially orthogonally to the longitudinal axis and facing towards the nozzle holder side, and
at the nozzle holder side of the ceramic nozzle hood, a collar comprising, on opposite sides, a second member contact face facing away from the injection side, and a mount contact face facing towards the injection side,
wherein the inner chamber of the ceramic nozzle hood comprises a blind hole section at the injection side of the ceramic nozzle hood, the blind hole section being fluidly connected to a remaining section of the inner chamber along the longitudinal axis through the first member contact face and to an outside of the ceramic nozzle hood via a plurality of nozzle spray holes.

2. The ceramic nozzle hood of claim 1, further comprising a region, in which the radial extension of the ceramic nozzle hood varies, and an inclined face extending on the inner surface of the ceramic nozzle hood at an angle smaller than 50° with respect to the longitudinal axis.

3. The ceramic nozzle hood of claim 2, further comprising a cylinder head contact face on the outer surface of the ceramic nozzle hood extending essentially orthogonal with respect to the longitudinal axis and facing towards the injection side.

4. The ceramic nozzle hood of claim 3, wherein the ceramic nozzle hood is cylindrically shaped, and at least one of the first member contact face, the second member contact face, the mount contact face, and the cylinder head contact face is ring-shaped.

5. The ceramic nozzle hood of claim 4, wherein the ceramic nozzle hood comprises one or more engineering ceramics including at least one of oxide ceramics such as zirconium oxide or aluminium oxide and non-oxide ceramics such as carbide ceramics and nitride ceramics.

6. The ceramic nozzle hood of claim 5, wherein the first member contact face and the second member contact face are configured for forming a first and second sealing zone, respectively, with corresponding hood contact faces of a member insertable into the ceramic nozzle hood.

7. An injection nozzle system, comprising
a needle,
a needle guide member configured to guide the needle between a fuel injection state and a sealed state of the injection nozzle system, and
a ceramic nozzle hood according to any one of claims 1 to 6 configured to essentially surround the needle guide member with the exception of a nozzle holder side face of the needle guide member.

8. The injection nozzle system of claim 7, wherein the first member contact face is configured to form a high pressure sealing with a first hood contact surface of the needle guide member, when a force is applied onto the mount contact face in the direction of the nozzle holder side of the ceramic nozzle hood (30), and in particular grooves are provided within first hood contact surface.

9. The injection nozzle system of claim 8, wherein in an unmounted state of the injection nozzle system a distance between the first member contact face and the second member contact face of the ceramic nozzle hood is less than a distance between corresponding first hood contact face and a second hood contact face of the needle guide member, thereby providing a tensile stress within the ceramic nozzle hood in a mounted state of the injection nozzle system.

10. The injection nozzle system of claim 9, wherein the needle guide member comprises a bore configured for guiding the needle between a fuel injection state and a closed state of the injection nozzle system, the bore of the needle guide member forms a high pressure chamber within an upper third of the needle guide member next to the nozzle holder side, and a high pressure supply bore extends from the high pressure chamber and opens into the nozzle holder side face of the needle guide member.

11. The injection nozzle system of claim 10, wherein in the mounted state, the ceramic nozzle hood and the needle guide member contact each other at a first sealing zone and at a second sealing zone and a gap is formed between the hood and the needle guide member and extends from the first sealing zone to the second sealing zone, and the injection nozzle system comprises further a pressure relief path extending through the gap and connecting the gap with an outside of the injection nozzle system at the nozzle holder side face.

12. The injection nozzle system of claim 11, further comprising a coolant path that extends within a gap between the ceramic nozzle hood and the needle guide member at in injection side of the injection nozzle system, the gap being sealed by a first high pressure sealing zone from a fuel supply path of the injection nozzle system and comprises an inflow and an outflow coolant conduits that are fluidly connected with the gap.

13. A method for mounting an injection nozzle system onto a nozzle holder, the injection nozzle system comprising a needle, a needle guide member configured to guide the needle between a fuel injection state and a sealed state of the injection nozzle system, and a ceramic nozzle hood configured to essentially surround the needle guide member with the exception of a nozzle holder side face of the needle guide member, wherein in an unmounted state of the injection nozzle system a distance between a first member contact face and a second member contact face of the ceramic nozzle hood is less than a distance between a first hood contact face and a second hood contact face of the needle guide member, the method comprising:
applying a force onto the ceramic nozzle hood in direction of the nozzle holder side of the ceramic nozzle hood, such that the first member contact face of the ceramic nozzle hood contacts the first hood contact face of the needle guide member, thereby forming a first sealing zone;
increasing the force onto the ceramic nozzle hood to stretch the ceramic nozzle hood such that the second member contact face of the ceramic nozzle hood contacts the second hood contact face of the needle guide member, thereby forming a second sealing zone; and
further increasing the force onto the ceramic nozzle hood to form a sealed contact between the needle guide member and the nozzle holder.

14. The method of claim 13, wherein the force onto the ceramic nozzle hood in direction of the nozzle holder side of the ceramic nozzle hood is applied at a mount contact face of a collar of the ceramic nozzle hood.

15. The method of claim 14, wherein the force onto the ceramic nozzle hood in direction of the nozzle holder side of the ceramic nozzle hood is applied via a mount interacting with the nozzle holder via a thread connection.
